(19) United States
(12) Patent Application Publication
(10) Pub. No.: US 2009/0224198 A1
(43) Pub. Date: Sep. 10, 2009

(54) ELECTRODE MATERIAL FOR ELECTROCHEMICAL ELEMENT AND COMPOSITE PARTICLE

(76) Inventors: Hidekazu Mori, Tokyo (JP); Masayoshi Matsui, Tokyo (JP)

Correspondence Address: BIRCH STEWART KOLASCH & BIRCH, PO BOX 747, FALLS CHURCH, VA, 22040-0747, US

(21) Appl. No.: 11/915,367

(22) PCT Filed: May 26, 2006
(86) PCT No.: PCT/JP2006/310525

§ 371 Date: Mar. 11, 2008

(30) Foreign Application Priority Data
May 26, 2005 (JP) 2005-153386
Aug. 8, 2005 (JP) 2005-229978

(51) Int. Cl. H01G 9/058

(52) U.S. Cl. 252/62.3 Q

(57) ABSTRACT

The present invention provides an electrochemical element electrode material that makes it possible to obtain an electrochemical element having both low internal resistance and high capacity, in particular to obtain an electrochemical element electrode having a uniform active material layer in roll molding at a high rate, and an electrode formed of the electrode material. The electrochemical element electrode material comprises composite particle (a) comprising electrode active material, electric conductive material, and fluororesin (a) having a structure unit obtained by polymerizing tetrafluoroethylene and having a melting point of 200° C. or higher, and amorphous polymer (b) not having a structure unit obtained by polymerizing tetrafluoroethylene and having a glass transition temperature of 180° C. or lower.

### TECHNICAL FIELD

The present invention relates to electrode material used for electrochemical elements such as a lithium ion secondary battery and an electric double layer capacitor (in the present specification, referred to simply as “electrode material”). More particularly, it relates to electrochemical element electrode material used preferably as material for an electric double layer capacitor.

### BACKGROUND ART

Electrochemical elements such as a lithium ion secondary battery and an electric double layer capacitor have advantageous characteristics that they are small, light weight, and their energy density are high, and they can be repeatedly charged and discharged, and accordingly their demand is expanding rapidly. The lithium ion secondary battery has a relatively large energy density, so it is used in fields such as cellular phones and notebook personal computers. Meanwhile the electric double layer capacitor can be rapidly charged and discharged, so it is used as a memory backup small power source in personal computers and the like. Furthermore, the electric double layer capacitor is expected to be applied as a large sized power source for electric vehicles. Moreover, the redox capacitor using the oxidation-reduction reaction (pseudo electricity double layer capacitance) on the surface of a metal oxide or a conductive polymer also attracts attention because of the large capacity thereof. As for these electrochemical elements and electrodes used therefor, along with the expansion of their applications, further more improvements are required for lower internal resistance, higher capacitance, more excellent mechanical properties and the like. Furthermore, there is a demand for a highly productive method of producing them.

The electrochemical element electrode can be obtained, for example, by forming electrochemical element electrode material comprising electrode active material and the like into the shape of a sheet, and by bonding this sheet (active material layer) onto a collector by pressing. As a method of producing active material layer continuously, the roll pressing method is known. For example, in Patent Document 1, a method is disclosed wherein raw material consisting of carbon fine powder, conductive agent, and binder are mixed, and the primary mixture is dried, press molded, and thereafter, crushed and classified to obtain an electrode material, and further, a method is described wherein the electrode material is roll pressed to obtain an active material layer as a sheet shape molded body. However, in this method, in order to obtain an electrode in the shape of a homogeneous sheet (electrode sheet), it is required to use a liquid lubricant which facilitates fibrosing of the binder. Moreover, since it is necessary to recover solvent in a subsequent step, the productivity is low and the producing process becomes complicated, which has been a problem.

### [Patent Document 1] Japanese Unexamined Patent Application Publication No. 2001-230158

Further, in Patent Documents 2, 3 and 4, a method is disclosed wherein electrode active material is fluidized in a fluidized bed, to which raw material dispersion comprising binder, electric conductive agent and solvent is sprayed to be granulated to obtain composite particle, and the composite particle as electrode material are roll pressed to give an electrode sheet. However, even if the electrode material described in these documents are used, it has not been possible to obtain electrode sheet continuously and stably, and the productivity has been low. Moreover, the electrochemical element obtained by use of such electrode sheet have not had sufficient cycle characteristics.

### [Patent Document 2] Japanese Unexamined Patent Application Publication No. 2005-26191

### [Patent Document 3] Japanese Unexamined Patent Application Publication No. 2005-78933

### [Patent Document 4] United States Patent Publication No. 2006/0064289

On the other hand, in Patent Document 5, a method is disclosed wherein slurry comprising electrode active material, binder comprising fine-particulate rubber, and dispersion medium is made into particle by the spray-drying method to obtain electrode material, and the electrode material is pressed in a mold to give active material layer. However, when the electrode material described in this document is roll-pressed at a high rate, it is not possible to obtain the electrode sheet continuously and stably, which has been another problem.

### [Patent Document 5] Japanese Unexamined Patent Application Publication No. 2004-247249

### DISCLOSURE OF THE INVENTION

### Problems to be Solved by the Invention

The object of the present invention is to provide electrochemical element electrode material for obtaining electrochemical element that has both low internal resistance and high capacity, in particular for obtaining an electrochemical element electrode having a uniform active material layer by roll press molding at a high rate stably, and an electrode formed by the electrode material.

### Means to Solve the Problems

The present inventors have made examinations wholeheartedly in order to attain the above object, as a result, the present inventors have found that by using electrochemical element electrode material comprising electrode active material, electric conductive material, and binder which comprises fluororesin having a specific melting point and amorphous polymer having a specific glass transition temperature, it is possible to solve the problems. And the present inventors have come to complete the present invention on the basis of the above findings.

According to a first aspect of the present invention, there is provided electrochemical element electrode material comprising:

composite particle (a) comprising electrode active material, electric conductive material, a fluororesin (a) and an amorphous polymer (b), and/or

a mixture of composite particle (A) comprising electrode active material, electric conductive material and fluororesin (a), and composite particle (B) comprising electrode active material, electric conductive material and amorphous polymer (b); wherein

the fluororesin (a) has a structure unit obtained by polymerizing tetrafluoroethylene and has a melting point of 200° C. or higher, and

the above amorphous polymer (b) does not have a structure unit obtained by polymerizing tetrafluoroethylene and has a glass transition temperature of 180° C. or lower.

It is preferable that the above electrochemical element electrode material comprises the composite particle (a) comprising the fluororesin (a) and the amorphous polymer (b).

Moreover, the above electrochemical element electrode material may comprise the mixture of the composite particle (A) which comprises the fluororesin (a) but does not comprise the amorphous polymer (b), and the composite particle (B) which does not comprise the fluororesin (a) but comprises the amorphous polymer (b).

It is preferable that the above electrochemical element electrode material further comprises a resin (c) other than the fluororesin (a) and the amorphous polymer (b), further preferably a solvent soluble resin(c).

According to a second aspect of the present invention, there is provided a composite particle (a) that comprises electrode active material, electric conductive material, and fluororesin (a) having a structure unit wherein tetrafluoroethylene are polymerized and having a melting point of 200° C. or higher, and amorphous polymer (b) not having a structure unit obtained by polymerizing tetrafluoroethylene and having a glass transition temperature of 180° C. or lower.

According to a third aspect of the present invention, there is provided a method (spray-dry granulating method) of producing composite particle comprising steps of

dispersing electrode active material, electric conductive material, and fluororesin (a) having a structure unit obtained by polymerizing tetrafluoroethylene and having a melting point of 200° C. or higher, and an amorphous polymer (b) not having a structure unit obtained by polymerizing tetrafluoroethylene and having a glass transition temperature of 180° C. or lower, in solvent to obtain slurry A, and

granulating by spray-drying of the slurry A.

According to a fourth aspect of the present invention, there is provided a method (fluidized granulating method) of producing composite particle comprising steps of

dispersing electric conductive material, and fluororesin (a) having a structure unit obtained by polymerizing tetrafluoroethylene and having a melting point of 200° C. or higher, and amorphous polymer (b) not having a structure unit obtained by polymerizing tetrafluoroethylene and having a glass transition temperature of 180° C. or lower, in solvent to obtain slurry B, and

fluidized-granulating by fluidizing of electrode active material in a column, and spraying of the slurry B thereto.

According to a fifth aspect of the present invention, there is provided an electrochemical element electrode wherein active material layer comprising the electrochemical element electrode material is laminated on a collector.

It is preferable that the active material layer is one formed by press molding, and further preferably one formed by roll-press molding.

Furthermore, it is preferable that the above electrochemical element electrode is used for an electric double layer capacitor.

### EFFECTS OF THE INVENTION

Using of the electrochemical element electrode material according to the present invention can result in molding active material layer stably at a high rate, which can attain high productivity. Moreover, Using of the electrochemical element electrode obtained in this manner can give an electrochemical element with a low internal resistance and a high capacity retention ratio when repeating charges and discharges. The electrochemical element electrode according to the present invention is especially suitable for electric double layer capacitors.

### BRIEF DESCRIPTION OF DRAWINGS

FIG. 1 is a figure showing an example of a method of producing an electrode.

FIG. 2 is a figure showing an example of a spray-drying apparatus used in the EXAMPLES.

### EXPLANATION OF SYMBOLS

1: Collector; 2: Active material layer; 3: Composite particle; 4: Feeder; 5: Roll

### BEST MODE FOR CARRYING OUT THE INVENTION

The electrochemical element electrode material of the present invention comprises

composite particle (a) containing electrode active material, electric conductive material, fluororesin (a) and amorphous polymer (b), and/or

a mixture of composite particle (A) containing electrode active material, electric conductive material, and fluororesin (a), and composite particle (B) containing electrode active material, electric conductive material, and amorphous polymer (b).

Therein, the above fluororesin (a) has a structure unit obtained by polymerizing tetrafluoroethylene and has melting point thereof of 200° C. or higher, and

the above amorphous polymer (b) does not have a structure unit obtained by polymerizing tetrafluoroethylene and has glass transition temperature of 180° C. or lower.

The electrode active material used for the present invention is appropriately selected according to the kinds of electrochemical elements. As the electrode active material for positive electrode of a lithium ion secondary battery, lithium containing composite metal oxides such as LiCoO₂, LiNiO₂, LiMnO₂, LiMn₂O₄, LiFePO₄, LiFeVO₄; transition metal sulfides such as TiS₂, TiS₃, amorphous MoS₃; transition metal oxides such as Cu₂V₂O₃, amorphous V₂O.P₂O₅, MoO₃, V₂O₅, V₆O₁₃, may be exampled. Furthermore, electric conductive polymers such as polyacetylene and poly-p-phenylene may be mentioned.

As the electrode active material for negative electrode of a lithium ion secondary battery, carbonaceous material such as amorphous carbon, graphite, natural graphite, meso carbon micro beads (MCMB), and pitch base carbon fiber; and conductive polymers such as polyacene may be mentioned. These respective electrode active materials may be used alone or in combination of two or more, according to the kinds of electrochemical elements. When the electrode active materials are used in combination, two or more kinds of electrode active materials having different particle diameters or particle diameter distributions may be employed in combination.

It is preferable that the shape of the electrode active material used for the electrode of a lithium ion secondary battery is granulated into spherical particles. If the shape of particle is spherical, a high density electrode can be formed. Moreover, mixture of fine particles with a particle diameter of about 1 μm and comparatively large particles with a particle diameter of 3 to 8 μm, or particles having a broad particle diameter distribution from 0.5 to 8 μm is preferable. It is preferable to use particles after filtering to remove particles having a particle diameter of 50 μm or more. Although the tap density of electrode active material is not limited in particular, but one of 2 g/cm³ or more is used preferably in the positive electrode, and one of 0.6 g/cm³ or more is preferably used in the negative electrode. Meanwhile, that tap density is the value as measured on the basis of ASTM D4164.

As the electrode active material for electric double layer capacitor, usually, carbonaceous allotrope is used. It is preferable that the electrode active material for electric double layer capacitor has a large specific surface area enough to form an interface of a larger area even with a same weight. In particular, it is preferable that the specific surface area is 30 m²/g or more, preferably from 500 to 5,000 m²/g, further preferably from 1,000 to 3,000 m²/g. Meanwhile, a specific surface area is the value as determined by the BET method. The measurement may be performed by use of a specific surface area measuring device Flow Sove III 2305 produced by Shimadzu Corp.

As specific examples of the carbonaceous allotrope, activated carbon, polyacene, carbon whisker, graphite, and the like may be mentioned, and powder or fiber of these can be used. A preferable electrode active material for electric double layer capacitor is activated carbon, and specifically, phenol base activated carbon, rayon base activated carbon, acryl base activated carbon, pitch base activated carbon, and coconut husk base activated carbon may be mentioned. As the electrode active material for electric double layer capacitor, these respective carbonaceous allotropes may be used alone, or in combination of two or more. When the carbonaceous allotropes are used in combination, two or more kinds of carbonaceous allotropes having different particle diameters or particle diameter distributions may be employed in combination.

Moreover, non-porous carbon which has micro crystallite carbon similar to graphite and the distance between layers of the micro crystallite carbon is expanded may be used as the electrode active material. Such non-porous carbon is obtained by dry-distilling graphitizable carbon with developed micro crystallite of multilayer graphite structure at 700 to 850° C., subsequently heat treating it with a caustic alkali at 800 to 900° C., and further removing residual alkali ingredient with heated steam if necessary.

As the electrode active material for electric double layer capacitor, when powder whose weight average particle diameter is 0.1 to 100 μm, preferably 1 to 50 μm, further preferably 5 to 20 μm is used, it is possible to easily thin down the electrode for electric double layer capacitor, and to make the electric capacity high, which is preferable. Herein, weight average particle diameter is the value that is obtained by multiplying the density and the volume average particle diameter as measured by laser diffraction-dispersion method together. The measurement may be performed by use of laser diffraction type particle size distribution measuring device SALD-3100 produced by Shimadzu Corp.

The electric conductive material used in the present invention is made of granulous allotropes of carbon which have electric conductivity, and do not have fine pores which can form electric double layer, and increase the conductivity of an electrochemical element electrode. The weight average particle diameter of electric conductive material is smaller than a weight average particle diameter of the electrode active material, and is in the range usually of 0.001 to 10 μm, preferably 0.05 to 5 μm, further preferably 0.01 to 1 μm. When the particle diameter of the electric conductive material is in this range, high conductivity may be provided by a smaller using amount. Specifically, electric conductive carbon black such as furnace black, acetylene black, and KETJEN BLACK (registered trademark of Aczo Nobel Chemicals B. V.); and graphites such as natural graphite and artificial graphite; may be mentioned. Of these, electric conductive carbon black is preferable, and acetylene black and furnace black are further preferable. These respective electric conductive material may be used alone or in combination of two or more.

The amount of the electric conductive material to 100 parts by weight of the electrode active material is usually in the range of 0.1 to 50 parts by weight, preferably 0.5 to 15 parts by weight, and further preferably 1 to 10 parts by weight. When the amount of the electric conductive material in this range is employed to obtain an electrode, it is possible to make high the capacity of an electrochemical element using the electrode and to make the internal resistance low.

The fluororesin (a) used in the present invention is a polymer having a structure unit obtained by polymerizing tetrafluoroethylene. The content of the structure unit obtained by polymerizing tetrafluoroethylene is preferably 40% by weight or more, and further preferably 60% by weight or more. It is surmised that the fluororesin (a) has an action to become fibrous form when producing composite particle and/or forming active material layer using the electrode material comprising the composite particle, which binds the composite particles to maintain the form of active material layer. When the content of the structure unit obtained by polymerizing tetrafluoroethylene in the fluororesin (a) is in the above range, the form of active material layer obtained is maintained, and accordingly, it becomes easy to produce electrochemical element electrode continuously at a high molding rate.

The fluororesin (a) has a melting point of 200° C. or higher, preferably no less than 250° C. and no more than 400° C. When the melting point is in this range, the forming processability of the electrode material obtained becomes excellent. As specific examples of such a fluororesin (a), poly tetrafluoroethylene (PTFE), tetrafluoroethylene—hexafluoropropylene copolymer (FEP), tetrafluoroethylene—perfluoroalkylvinylether copolymer (PFA), ethylene—tetrafluoroethylene copolymer (ETFE), and the like may be mentioned, and especially PTFE is preferable. In addition, a melting point is the value as measured by heating up at 5° C. per minute by use of a differential scanning calorimeter (DSC).

The amorphous polymer (b) used in the present invention is a polymer that does not have a structure unit obtained by polymerizing tetrafluoroethylene, and has a glass transition temperature (Tg) of 180° C. or lower, preferably −50° C. or higher and 120° C. or lower. When Tg is in this range, the binding property and the binding durability become excellent, and the electrochemical element obtained is excellent in the durability when repeating charges and discharges. Meanwhile, glass transition temperature is the value as measured by heating up at 5° C. per minute by use of a differential scanning calorimeter (DSC).

It is preferable that the amorphous polymer (b) is a polymer with the property to be dispersed in any solvent, preferably the solvent used preparing slurry A or slurry B mentioned later herein. As specific examples of such a polymer, diene polymer, acrylate polymer, polyimide, polyamide, polyurethane, and the like may be mentioned, and preferably, diene polymer and acrylate polymer may be mentioned. These polymers may be used alone or in combination of two or more.

The diene polymer is homopolymer of conjugated diene or copolymer obtained by polymerizing a monomer mixture containing conjugated diene, or hydrogenation product thereof. The content of the conjugated diene in the monomer mixture is usually 40% by weight or more, preferably 50% by weight or more, and further preferably 60% by weight or more. Specifically, conjugated diene homopolymers such as polybutadiene, and polyisoprene; copolymer of aromatic vinyl and conjugated diene such as styrene—butadiene copolymer (SBR) and the like which may be carboxy-modified; copolymer of vinyl cyanide and conjugated diene such as acrylonitrile—butadiene copolymer (NBR) and the like; hydrogenated SBR, hydrogenated NBR, and the like may be mentioned.

The acrylate polymer is homopolymer of acrylic acid ester and/or methacrylic acid ester or copolymer obtained by polymerizing a monomer mixture containing these. The content of the acrylic acid ester and/or the methacrylic acid ester in the monomer mixture is usually 40% by weight or more, preferably 50% by weight or more, and further preferably 60% by weight or more. As specific examples of the acrylate polymer, cross-linked acrylate polymers such as 2-ethylhexyl acrylate—methacrylic acid—acrylonitrile—ethylene glycol dimethacrylate copolymer, 2-ethylhexyl acrylate—methacrylic acid—methacrylonitrile—diethylene glycol dimethacrylate copolymer, 2-ethylhexyl acrylate—styrene—methacrylic acid—ethylene glycol dimethacrylate copolymer, butyl acrylate—acrylonitrile—diethylene glycol dimethacrylate copolymer and butyl acrylate—acrylic acid—trimethylol propane trimethacrylate copoymer; copolymers of ethylene and acrylic(methacrylic) acid ester such as ethylene—methyl acrylate copolymer, ethylene—methyl methacrylate copolymer, ethylene—ethyl acrylate copolymer, ethylene—ethyl methacrylate copolymer; and graft polymers where a radical polymerizable monomer is grafted to the copolymer of ethylene and acrylic(methacrylic) ester; and the like may be mentioned. In addition, as the radical polymerizable monomer used for the above graft polymer, methyl methacrylate, acrylonitrile, methacrylic acid, and the like may be mentioned. In addition, copolymer of ethylene and acrylic(methacrylic) acid such as ethylene—acrylic acid copolymer, ethylene—methacrylic acid copolymer may be mentioned.

Among these, the diene polymer and the cross-linked acrylate polymer are preferable, and the cross-linked acrylate polymer is in particular preferable, from the viewpoints that they can obtain active material layer excellent in binding property with a collector and surface smoothness, moreover, they enable to produce electrode for electrochemical element with high electric capacity and low internal resistance.

Although the form of the amorphous polymer (b) is not limited in particular, it is preferable that the shape is particulate since its binding property is good, and the decline of the electric capacity and the degradation by the repetition of charge and discharge can be restrained in the produced electrodes. As the particulate amorphous polymer (b), for example, one in the state where the particle of the polymer are dispersed in the solvent like Latex, and powdered one obtained by drying such dispersion may be employed.

Moreover, the amorphous polymer (b) used in the present invention may be polymer particle which have a core-shell structure obtained by step-by-step polymerizing two or more kinds of monomer mixtures. It is preferable that the polymer particle which have the core shell structure are produced by first polymerizing the monomer that gives the first step polymer to obtain seed particles, and polymerizing the monomer that gives the second step polymer in the presence of the seed particles.

Although the ratio of the core and the shell in the polymer particle having the core-shell structure is not limited in particular, the weight ratio of core portion:shell portion is usually 50:50˜99:1, preferably 60:40˜99:1, and further preferably 70:30˜99:1. Polymer composing of the core portion or the shell portion may be selected from the above polymers. As for the core portion and the shell portion, it is preferable that one of these has a glass transition temperature below 0° C., and, the other has a glass transition temperature of 0° C. or higher. Moreover, the difference of the glass transition temperature of the core portion and the shell portion is usually 20° C. or more, and preferably 50° C. or more.

Although number average particle diameter of the particulate amorphous polymer (b) used in the present invention is not limited in particular, it is usually from 0.0001 to 100 μm, preferably from 0.001 to 10 μm, and further preferably from 0.01 to 1 μm. When the average particle diameter of the amorphous polymer (b) is in this range, it is possible to give excellent binding property to the active material layer even by use of a small amount of the amorphous polymer (b). Herein, number average particle diameter is determined as the arithmetic average value of measured diameters of 100 polymer particles chosen at random by use of a transmission electron microscope photograph. The shape of particle may be either spherical or irregular.

Using of the fluororesin (a) which has a melting point in the above range and the amorphous polymer (b) which has Tg in the above range can allow to form active material layer at a high molding rate. Moreover, it is possible to improve the durability of the electrochemical element to be obtained when repeating the charge and discharge.

The composite particle (α) of the present invention comprises electrode active material, electric conductive material, fluororesin (a) having a structure unit obtained by polymerizing tetrafluoroethylene and having a melting point of 200° C. or higher, and amorphous polymer (b) not having a structure unit obtained by polymerizing tetrafluoroethylene and having a glass transition temperature of 180° C. or lower.

The composite particle (A) comprises the electrode active material, the electric conductive material, and the above fluororesin (a), and preferably does not comprise the above amorphous polymer (b).

The composite particle (B) comprises the electrode active material, the electric conductive material, and the above amorphous polymer (b), and preferably does not comprise the above fluororesin (a).

As a specific aspect of the electrode material according to the present invention, there are (i) one comprising the composite particle (a), and (ii) the other comprising the composite particle (A) and the composite particle (B) in combination.

Moreover, in the aspect of (i) or (ii), one which comprises the composite particle (a) alone, one which comprises combination of the composite particle (a) and the composite particle (A), one which comprises combination of the composite particle (a) and the composite particle (B), one which comprises combination of the composite particle (a), the composite particle (A) and the composite particle (B), and one which comprises combination of the composite particle (A) and the composite particle (B) are included.

Of these, the electrode material which comprises the composite particle (a) alone is preferable because it leads to excellent productivity and homogeneity of the electrode to be obtained.

The sum total of the contents of the fluororesin (a) and the amorphous polymer (b) in the electrode material according to the present invention, to 100 parts by weight of the electrode active material, is in the range of usually 0.1 to 50 parts by weight, preferably 0.5 to 20 parts by weight, and further preferably 1 to 10 parts by weight. Moreover, the weight ratio of the content of the fluororesin (a): the content of the amorphous polymer (b) in the electrode material according to the present invention is preferably 20:80 to 80:20, further preferably 30:70 to 70:30, and in particular preferably 40:60 to 60:40. Herein, the contents of the fluororesin (a) and the amorphous polymer (b) are determined on the basis of the total amount of the fluororesin (a) and the amorphous polymer (b) which are contained in all the composite particle (hereinafter, “composite particle” to be used as the general term of the composite particle (a), the composite particle (A), and the composite particle (B)) used for the electrode material according to the present invention, and the fluororesin (a) and the amorphous polymer (b) which are added to the electrode material from other than the composite particle.

Further, the weight ratio of the content of the fluororesin (a): the content of the amorphous polymer (b), in the composite particle (a) is preferably 20:80 to 80:20, further preferably 30:70 to 70:30, and in particular preferably 40:60 to 60:40. When the ratio of the contents of the fluororesin (a) and the amorphous polymer (b) is in this range, it is possible to especially increase the molding rate and the durability of the electrochemical element to be obtained when repeating the charge and discharge.

It is preferable that the electrode material in the present invention further comprises a resin (c) other than the fluororesin (a) and the amorphous polymer (b), preferably a resin which is soluble in the solvent and can make the amorphous polymer (b) dispersed (hereinafter, referred to as “soluble resin”). It is preferable that the soluble resin is comprised in the above composite particle. The soluble resin is preferably dissolved in the solvent used when preparing the slurry A or the slurry B mentioned later herein, and it has the function to disperse the electrode active material, the electric conductive material, and the like uniformly in the solvent. The soluble resin may have or may not have binding attraction.

As the soluble resin, cellulose polymers such as carboxymethyl cellulose, methyl cellulose, ethyl cellulose and hydroxypropyl cellulose, and ammonium salt or alkaline metal salt of these; poly acrylic(methacrylic) acid salts such as sodium polyacrylate(methacrylate) and the like; polyvinyl alcohol, modified polyvinyl alcohol, polyethyleneoxide; polyvinylpyrrolidone, polycarboxylic acid, starch oxide, starch phosphate, casein, various modified starches, a chitin, chitosan derivatives, and the like may be mentioned. These respective soluble resins may be used alone or may be used in combination of two or more. In particular, cellulose polymers are preferable, and carboxymethyl cellulose, or its ammonium salt or alkaline metal salt are in particular preferable.

Although the use amount of the soluble resin is not limited in particular, the use amount thereof to 100 parts by weight of the electrode active material, is in the range of usually 0.1 to 10 parts by weight, preferably 0.5 to 5 parts by weight, and further preferably 0.8 to 2 parts by weight. Using of the soluble resin can result in preventing the solid contents in the slurry A and the slurry B from sedimentation or condensation. Moreover, since clogging of the atomizer when spray-drying can be prevented, it is possible to perform the spray-drying stably and continuously.

The electrode material according to the present invention may further comprise other additives if needed. As the other additive, for example, there is surfactant. It is preferable that the surfactant is comprised in the composite particle. As the surfactant, mentioned are anionic surfactants, cationic surfactants, nonionic surfactants, and ampholytic surfactants such as nonionic anionic surfactant. Of these, anionic surfactant or nonionic surfactant which are easily thermally decomposed are especially preferable. The use amount of the surfactant is not limited in particulate, but the use amount thereof, to 100 parts by weight of the electrode active material, is in the range of 0 to 50 parts by weight, preferably 0.1 to 10 parts by weight, and further preferably 0.5 to 5 parts by weight.

The weight average particle diameter of the composite particle is in the range of usually 0.1 to 1000 μm, preferably 5 to 500 μm, and further preferably 10 to 100 μm.

Although the composite particle used for the present invention is not particularly limited by the producing method thereof, preferably the composite particle may be easily obtained by the spray-dry granulation method or the fluidized granulation method. In the spray-dry granulation method or the fluidized granulation method, if the fluororesin (a) and the amorphous polymer (b) are used together as binder, the composite particle (α) can be obtained. Moreover, if the fluororesin (a) or the amorphous polymer (b) is used alone as binder, the composite particle (A) or the composite particle (B) can be obtained respectively. Especially, these granulation methods are preferable, because it is possible to produce the composite particle (a) at high productivity.

The spray-dry granulation method in the present invention is specifically a method comprising steps of dispersing the electrode active material, the electric conductive material and the binder, and the soluble resin if necessary in solvent to obtain slurry A, and spray-drying the slurry A for granulation.

In the spray-dry granulation method, first, the electrode active material, the electric conductive material and the binder, and the soluble resin and other additives if necessary, are dispersed or dissolved in solvent to give slurry A in which the electrode active material, the electric conductive material, the binder, and the soluble resin and other additives if necessary are dispersed or dissolved.

The solvent used in order to obtain the slurry A is not limited specifically, but when the above soluble resin is used, a solvent which can dissolve the soluble resin is preferably used. As the solvent used to obtain the slurry A, water is usually used, meanwhile organic solvent may also be used. As the organic solvent, for example, alkyl alcohols such as methyl alcohol, ethyl alcohol, and propyl alcohol; alkyl ketones such as acetone, and methylethylketone; ethers such as tetrahydrofuran, dioxane, and diglyme; amides such as diethyl formamide, dimethyl acetamide, N-methyl-2-pyrrolidone, and dimethyl imidazolidinone; sulfur containing solvents such as dimethyl sulfoxide, and sulfolane; may be mentioned. Of these, alcohols are preferable.

If water and an organic solvent whose boiling point is lower than that of water are used together, it is possible to make the drying rate fast when spray drying. Moreover, since the dispersibility of the binder or the solubility of the soluble resin changes, and the viscosity and flowability of the slurry A may be adjusted by the quantity or the kind of the organic solvent, which can improve the producing efficiency. The amount of the solvent used in preparing the slurry A is such that the solid content concentration of the slurry A should be in the range of usually 1 to 50% by weight, preferably 5 to 50% by weight, and further preferably 10 to 30% by weight.

Method or procedure to disperse or dissolve the electrode active material, the electric conductive material, the binder, and the soluble resin and other additives if necessary in the solvent is not limited in particular, for example, a method of adding the electrode active material, the electric conductive material, the binder, and the soluble resin to the solvent to mix them; a method of dissolving the soluble resin in the solvent, and adding the binder which is dispersed in the solvent (for example, Latex) to mix them, and finally adding the electrode active material and the electric conductive material to mix them; a method of adding the electrode active material and the electric conductive material to dispersion of the binder in the solvent to mix them, to which adding the solution of the soluble resin in the solvent to mix them may be mentioned. As means for mixing, for example, mixing machines such as a ball mill, a sand mill, a pigment dispersing machine, a crushing machine, an ultrasonic dispersing machine, a homogenizer, a planetary mixer may be mentioned. The mixing is usually performed in the range of room temperature to 80° C., and for 10 minutes to several hours.

Next, the above slurry A is spray-dried to be granulated. An atomizer is mentioned as a typical apparatus used for spray-drying. In the atomizer, there are two types of apparatuses, that is the rotatary disk type atomizer and the pressurization type atomizer. The rotatary disk type atomizer is one wherein the slurry is supplied at roughly the center of a disk which rotates at a high speed, and the slurry is discharged outside of the disk by the centrifugal force of the disk to be spray-dried. The rotation rate of the disk depends upon the size of the disk, and it is usually 5,000 to 30,000 rpm, preferably 15,000 to 30,000 rpm. On the other hand, the pressurization type atomizer is one wherein the slurry A is pressurized and sprayed in shape of mist from a nozzle to be dried. The temperature of the slurry A to be atomized is usually at the room temperature, but it may be warmed to higher than the room temperature.

The hot wind temperature when spray-drying is usually from 80 to 250° C., preferably from 100 to 200° C. In the spray-drying method, the method to blow a hot wind is not limited in particular, and for example, a method in which the hot wind goes in parallel to the direction of atomizing in the horizontal direction, a method in which atomizing is carried out in the drying column top part and the mist of the slurry falls with the hot wind, a method in which the atomized mist and the hot wind contact in countercurrent, a method in which the atomized mist first goes in parallel with the hot wind, subsequently falls by gravity to contact the hot wind in countercurrent may be mentioned.

Although the composite particle can be obtained by the above method, heat treatment may be further made in order to stiffen the surface of the composite particle. The heat treatment temperature is usually from 80 to 300° C.

The fluidized granulation method in the present invention is specifically a method comprising steps of dispersing the electric conductive material and the binder in the solvent to obtain the slurry B, and atomizing the above slurry B to the electrode active material which is fluidized in a column to fluidized-granulate them.

In the fluidized granulation method, first, the electric conductive material, the binder, and the soluble resin and other additives if necessary are dispersed or dissolved in the solvent to obtain the slurry B. As the solvent used in order to obtain the slurry B, the same ones mentioned in the above spray-dry granulation method may be employed. The amount of the solvent used in preparing the slurry B is the one at which the solid content concentration of the slurry B should be in the range of usually 1 to 50% by weight, preferably 5 to 50% by weight, and further preferably 10 to 30% by weight. The amount of the solvent is in this range allows the binder to be preferably dispersed uniformly.

Method or procedure to disperse or dissolve the electric conductive material and the binder, and the soluble resin if necessary in the solvent is not limited in particular, but for example, mentioned may be a method of adding the electric conductive material, the binder, and the soluble resin to the solvent to mix them; a method of dissolving the soluble resin in the solvent, adding the binder which is dispersed in the solvent (for example, Latex) to mix them and finally adding the electric conductive material to mix them; a method of adding the electric conductive material to the solution of the soluble resin in the solvent to mix them, and to which adding the dispersion of the dispersible binder in the solvent to mix them. As means for mixing, for example, mixing machines such as a ball mill, a sand mill, a beads mill, a pigment dispersing machine, a crushing machine, an ultrasonic dispersing machine, a homogenizer, a planetary mixer may be mentioned. The mixing is usually performed in the range of room temperature to 80° C., and for 10 minutes to several hours.

Next, the electrode active material is fluidized in a column, and the above slurry B is sprayed thereto to carry out fluidized-granulation. As the fluidized-granulation method in the column, a method by a fluidized bed, a method by a modified fluidized bed, a method by a spouted bed, and the like may be mentioned. In the method by a fluidized bed, the electrode active material is fluidized by a hot wind, to which the above slurry B is atomized from a spray and the like to perform agglomeration granulation. The method by a modified fluidized bed is same as the method by a fluidized bed except that a circulation flow is given in the bed, and the granulated matter which grows comparatively large is discharged with the classifying effect. Moreover, in the method by a spouted bed, the slurry B which is from a spray and the like is adhered to coarse particle of the electrode active material by use of the feature of a spouted bed, and is simultaneously dried for granulation. As the process of the present invention, among these three methods, the method by a fluidized bed or the method by a modified fluidized bed are preferable. Although the temperature of the slurry B to be sprayed is usually at the room temperature, it may be warmed to higher than the room temperature. The temperature of the hot wind used for fluidization is usually from 80 to 300° C., and preferably from 100 to 200° C.

By the above method, the composite particle can be obtained, meanwhile, following the above fluidized granulation, rolling granulation may be carried out further. As the rolling granulation method, mentioned are a rotary plate method, a rotary cylinder method, and a rotary head cut cone method, and the like. In the rotary plate method, the above slurry and the binder if necessary are sprayed to the composite particle supplied in an inclined rotary plate to generate condensation granulated matter, and the granulated matter which grows comparatively large is discharged from a rim by use of the classifying effect of the rotary plate. In the rotary cylinder method, wet composite particle is supplied to the inclined rotary cylinder to be rolled in the cylinder, and the above slurry and the binder if necessary are sprayed thereto to obtain condensation granulated matter. The rotary head cut cone method is same as the operation of the rotary cylinder except that the granulated matter which grows comparatively large is discharged by use of the classifying effect of the condensation granulated matter by the head cut cone. Although the temperature at the time of rolling granulation is not limited in particular, in order to remove the solvent in the slurry, the temperature is usually from 80 to 300° C., preferably from 100 to 200° C. Furthermore, in order to harden the surface of the composite particle, heat treatment may be performed. The temperature of the heat treatment is usually from 80 to 300° C. If one of the fluororesin (a) and the amorphous polymer (b) is used as the binder for the fluidized granulation, and the other of these is used as the binder for the rolling granulation, it is possible to obtain the composite particle (α).

The electrode material in the present invention may comprise other binders and other additives than the above composite particle if needed, meanwhile, the amount of the composite particle comprised in the electrode material is usually 50% by weight or more, preferably 70% by weight or more, further preferably 90% by weight or more.

As the other binders comprised in the electrode material if needed, the same ones as mentioned as the fluororesin (a) and the amorphous polymer (b) may be mentioned. Since the above composite particle has already contained the binder, in preparing the electrode material, it is not necessary to add the other binder separately, but in order to increase the binding force of the composite particle, the other binder may be added when the electrode material is prepared. In the amount of the other binder to be added when preparing the electrode material, the sum total amount with the binder in the composite particle, to 100 parts by weight of the electrode active material, is in the range of usually 0.1 to 50 parts by weight, preferably 0.5 to 20 parts by weight, and further preferably 1 to 10 parts by weight. The other additives include, besides the soluble resin and the surfactants, forming assistants such as water and alcohol, and the amount which does not spoil the effect of the present invention may be chosen appropriately and may be applied.

The electrochemical element electrode according to the present invention (hereinafter referred to simply as “electrode”) is made by laminating active material layer comprising the above electrochemical element electrode material according to the present invention on a collector. As the material of the collector used for the electrode, for example, mentioned are metal, carbon, conductive polymer, and the like, and metal is used preferably. As the metal for the collector, mentioned are usually aluminum, platinum, nickel, tantalum, titanium, stainless steel, and others alloy. Among these, aluminum or aluminum alloy is preferable from the viewpoint of conductivity and voltage resistance. Moreover, when high voltage resistance is required, the high-grade aluminum disclosed in Japanese Unexamined Patent Application Publication No. 2001-176757 may be used preferably. The collector is a film or a sheet, and although the thickness thereof is suitably chosen according to applications, it is usually from 1 to 200 μm, preferably from 5 to 100 μm, more preferably from 10 to 50 μm.

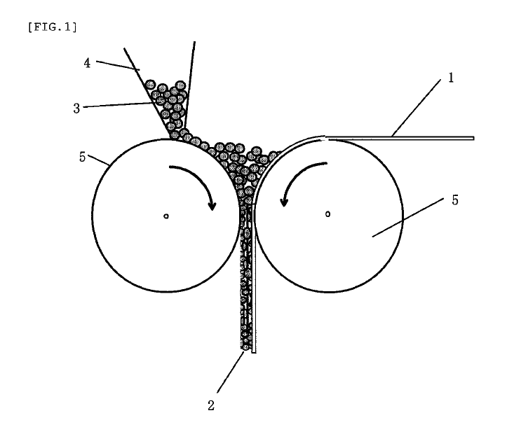

Although the active material layer may be fabricated by forming the electrochemical element electrode material into a sheet and laminating the sheet subsequently on the collector, meanwhile, it is preferable to directly form the electrochemical element electrode material into the active material layer on the collector. As the method of forming the active material layer which comprises the electrochemical element electrode material, there are dry molding methods such as a press molding method and wet molding methods such as an application method. The dry molding methods are preferable, since the drying step is unnecessary, the electrode can be produced with high productivity, and it is easy to be able to form thick active material layer uniformly. As the dry molding methods, there are a press molding method, an extrusion molding method (referred to also as paste extrusion) and the like. In the press molding method, the electrochemical element electrode material is pressed to be densified by re-arrangement and modification of the electrode material, which forms the active material layer. In the extrusion molding method, the electrochemical element electrode material is extruded by an extrusion molding machine into a film, a sheet and the like. The extrusion molding method can continuously form the active material layer as a long object. Among these, it is preferable to use the press molding method since it can be made by simple equipment. As the press molding method, there are, for example, as shown in FIG. 1, a roll-press molding method wherein the electrode material 3 comprising the composite particle is supplied to a roll-press molding apparatus 5 through a feeder 4 such as a screw feeder to form the active material layer, and a method wherein the electrode material is spread on the collector 1, and the electrode material is leveled by a blade or the like to adjust its thickness, and then it is formed by a pressure molding apparatus, a method wherein the electrode material is filled up in cavity of a mold and the mold is pressurized for formation and the like.

Among these press molding methods, the roll-press molding method is preferable. In the roll-press molding method, the active material layer 2 may be directly laminated on the collector by sending the collector 1 between the rolls at the same time when the electrode material 3 is supplied. It is preferable that the temperature when forming is usually from 0 to 200° C., and it is preferably higher than Tg of the amorphous polymer (b), and further preferably 20° C. or higher than Tg. In the roll-press molding, the molding rate is usually from 0.1 to 20 m/min, and preferably from 1 to 10 m/min. Moreover, the line pressure between rolls is usually from 0.2 to 30 kN/cm, and preferably from 0.5 to 10 kN/cm.

In order to eliminate uneven thickness of the formed electrode, to increase the density of the active material layer and to achieve high capacitance, post-pressing may be performed further if needed. As the method of post-pressing, pressing step by rolls is generally performed. In the roll pressing step, two cylindrical rolls are arranged vertically in parallel with each other with a narrow interval, and they are rotated in opposite directions, and an electrode is inserted between the rolls to be pressurized. The temperature of the rolls may be adjusted by heating or cooling.

### EXAMPLES

The present invention is explained still more specifically with reference to Examples and Comparative Examples hereafter, however, the present invention is not limited to the following Examples. Moreover, part and % are by weight, unless otherwise specified.

Respective characteristics of the electrode and the electric double layer capacitor were measured according to the following method.

### (Electrode Density)

The formed active material layer was cut into size of 40 mm×60 mm, and the weight and volume were measured, the electrode density was obtained as the density of the active material layer to be computed.

### (Capacity and Internal Resistance)

The electrode sheet was punched out to obtain two circular electrodes with diameter of 12 mm. The active material layers in the circular electrodes were opposed each other, and a rayon separator having a thickness of 35 μm was put between them. To this, electrolyte solution in which triethylmethylammonium tetrafluoroborate was dissolved in propylene carbonate at concentration of 1.5 mol/L was impregnated under decompression to give a coin cell CR2032 type electric double layer capacitor.

The obtained electric double layer capacitor was charged at 25° C. for 10 minutes at constant current 10 mA from 0V to 2.7V, and then to 0V, it was discharged at fixed current 10 mA. From the obtained charge-discharge curve, capacitance was calculated, and it was divided by the weight of only the active material layer of the above electrode to give a capacitance per unit weight of the active material layer. Moreover, an internal resistance was determined from the charge-discharge curve according to the calculation method of the standard RC-2377 specified by the Japan Electronics and Information Technology Industries Association.

### (Capacity Retention Ratio)

300 cycles of charge and discharge were repeated in the same manner as the above, and the electrostatic capacity after 300 cycles to the first-time electrostatic capacity expressed by percent is made the capacity retention ratio.

### Example 1

To obtain slurry A1 having solid content of 20%, 100 parts of electrode active material (activated carbon having a specific surface area of 2000 m²/g and weight average particle diameter of 5 μm), 5 parts of electric conductive material (acetylene black “Denka Black Powder” with weight average particle diameter of 0.7 μm: produced by Denki Kagaku Kogyo K.K.), 4.65 parts of 64.5% aqueous dispersion of fluororesin (a) (melting point: 327° C., PTFE aqueous dispersion “D-2CE”; produced by Daikin Industries, Ltd.), 7.5 parts of 40% aqueous dispersion of amorphous polymer (b) (cross-linked acrylate polymer “AD211” with number average particle diameter of 0.15 μm, glass transition temperature of −40° C.: produced by Zeon corporation), 93.3 parts of soluble resin (1.5% solution of carboxymethyl cellulose “DN-800H” produced by Daicel Chemical Industries, Ltd.), and 339.7 parts of ion exchanged water were stirred and mixed by a TK homomixer (produced by Tokushu Kika Kogyo Co., Ltd.).

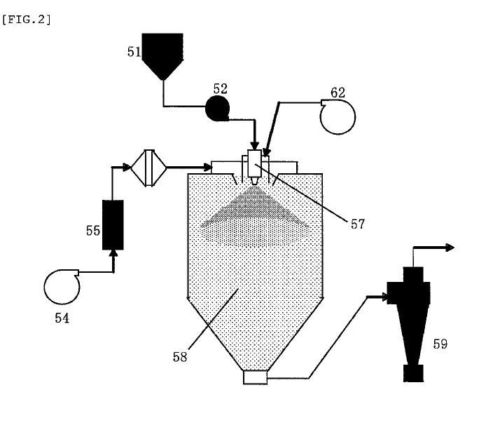

Subsequently, as shown in FIG. 2, the slurry A1 was charged into a hopper 51 of a spray drier (produced by Ohkawara Kakohki Co. Ltd.), sent to the top nozzle 57 by the pump 52, and sprayed from the nozzle into the drying column 58. At the same time, 150° C. hot wind was sent into the drying column 58 from the side of the nozzle 57 through the heat exchanger 55 to obtain a spherical composite particle (α-1) having average particle diameter of 50 μm. The obtained composite particle (α-1), as shown in FIG. 1, was supplied as the electrode material between rolls 5 (roll temperature=100° C., press line pressure=3.9 kN/cm) in a roll pressing machine (pushing cut rough surface heat roll; produced by Hirano Engineering Research Institute Ltd.), and is formed into a sheet at molding rate of 10.0 m/min to obtain active material layer having thickness of 300 μm, width of 10 cm, and density of 0.59 g/cm³. Apart from this, paint for collector (“Bunny Height T602”: produced by Nippon Graphite Industries, ltd.) was applied on an aluminum foil having thickness of 40 μm and dried to form a conductive adhesive layer, which resulted in giving a collector. The active material layer obtained above was stuck with the collector to obtain an electrode sheet. The characteristic of the electric double layer capacitor obtained using this electrode sheet is shown in Table 1.

TABLE 1

| | | | | | | Comparative | |
|---|---|---|---|---|---|---|---|
| amount of binder | | Example | | | | Example | |
| (solid content) [part] | | 1 | 2 | 3 | 4 | 1 | 2 |
| Fluororesin (a) | PTFE | 3 | 3 | 3 | 3 | 6 | — |
| component | | | | | | | |
| Amorphous | Crosslinked | 3 | — | 3 | 2 | — | — |
| polymer (b) | acrylate | | | | | | |
| component | base | | | | | | |
| | polymer | | | | | | |
| | Denatured | — | 2 | — | — | — | 3 |
| | styrene- | | | | | | |
| | butadiene | | | | | | |
| | copolymer | | | | | | |

| | | | | | | |
|---|---|---|---|---|---|---|
| Producing method | Spray | Spray | Spray | Fluidized | Spray | Fluidized |
| for Composite particle | Dry | Dry | Dry | granula- | Dry | granula- |
| | granula- | granula- | granula- | tion | granula- | tion |
| | tion | tion | tion | | tion | |
| Molding method | Roll | Roll | Sheetfed | Roll | Roll | Roll |
| | molding | molding | Press | molding | molding | molding |
| Molding rate[m/min] | 10 | 10 | — | 10 | 10 *¹⁾ | 10 |
| Electrode thickness[μm] | 300 | 290 | 290 | 300 | 290 | — *²⁾ |
| Electrode density[g/cm³] | 0.59 | 0.59 | 0.59 | 0.59 | 0.6 | — |
| Electrostatic | 55 | 56 | 53 | 55 | 56 | — |
| capacitance[F/g] | | | | | | |
| Internal resistance[Ω] | 11.3 | 11 | 11.5 | 11 | 11.5 | — |
| Capacity retention ratio[%] | 93.8 | 93.6 | 93.8 | 93.5 | 90.5 | — |

*¹⁾ Continuous molding impossible
*²⁾ Molding impossible

### Example 2

Spherical composite particle (α-2) having average particle diameter of 50 μm were obtained in the same manner as in the Example 1 except that 5 parts of 40% aqueous dispersion of denatured styrene-butadiene copolymer having a glass transition temperature of −5° C. (“BM-400B”: produced by Zeon Corporation) was used in place of 7.5 parts of the aqueous dispersion of cross-linked acrylate polymer “AD211” as the amorphous polymer (b). By use of the obtained composite particle (α-2) as the electrode material, roll molding was carried out in the same manner as in the example 1 to obtain an active material layer having thickness of 290 μm, width of 10 cm, and density of 0.59 g/cm³. By use of the active material layer, an electrode sheet was obtained in the same manner as in the example 1. The characteristic of the electric double layer capacitor obtained using the electrode sheet is shown in Table 1.

### Example 3

The composite particle (α-1) obtained in the example 1 as the electrode material was spread on an aluminum collector having thickness of 40 μm to be leveled uniformly, and which was press-molded with a sheet-fed hot press at 120° C. and pressure 4 MPa to obtain an active material layer having thickness of 290 μm, width of 10 cm, and density of 0.59 g/cm³. By use of the active material layer, an electrode sheet was obtained in the same manner as in the example 1. The characteristic of the electric double layer capacitor obtained using of the electrode sheet is shown in Table 1.

### Example 4

To prepare slurry B1 having solid content concentration of 8%, 2 parts of the electric conductive material (Denka Black powder), 4.65 parts of 64.5% PTFE aqueous dispersion “D-2CE” as the fluororesin (a), 5 parts of 40% cross-linked acrylate polymer aqueous dispersion “AD211” as the amorphous polymer (b), 3.33 parts of 4% solution of carboxymethyl cellulose as the soluble resin (“DN-10L”: produced by Daicel Chemical Industries Co. Ltd.), 17.76 parts of 1.5% aqueous solution of carboxymethyl cellulose (“DN-800H”), and 35.3 parts of ion exchanged water were mixed.

Into AggloMaster produced by Hosokawa Micron Corp., 100 parts of an electrode active material (activated carbon having specific surface area of 2000 m²/g and weight average particle diameter of 5 μm) was charged, and it was fluidized by 80° C. hot wind. And the slurry B1 was atomized in the AggloMaster to carry out fluidized granulation, which allowed to obtain composite particle having average particle diameter of 40 μm. By use of the obtained composite particle as the electrode material, roll molding was carried out in the same manner as in the example 1 to obtain an active material layer having thickness of 290 μm, width of 10 cm, and density of 0.59 g/cm³. An electrode sheet was obtained by use of the active material layer in the same manner as in the example 1. The characteristic of the electric double layer capacitor obtained using the electrode sheet is shown in Table 1.

### Comparative Example 1

Spherical composite particle (A-1) having average particle diameter of 50 μm was obtained in the same manner as in the example 1 except that the aqueous dispersion of cross-linked acrylate polymer “AD211” as the amorphous polymer (b) was not used, and the use amount of the 64.5% PTFE aqueous dispersion “D-2CE” as the fluororesin (a) was changed into 9.3 parts. By use of the obtained composite particle (A-1) as the electrode material, roll molding was carried out in the same manner as in the example 1. As the result, the composite particle attached together in the feeder and on the roll, and the composite particle could not be supplied stably between the rolls, which could not lead to form the active material layer continuously. By use of the active material layer being the portion that can be made, an electrode sheet was obtained in the same manner as in the example 1. And the characteristic of the electric double layer capacitor obtained using the electrode sheet is shown in Table 1.

### Comparative Example 2

Spherical composite particle (B-1) having average particle diameter of 40 μm was obtained in the same manner as in the example 1 except that the “D-2CE” as a fluororesin (a) was not used, and 7.5 parts of 40% aqueous dispersion of carboxy-modified styrene-butadiene copolymer “BM-400B” was used in place of 5 parts of aqueous dispersion of cross-linked acrylate polymer “AD211”. By use of the obtained composite particle (B-1) as the electrode material, in the same manner as in the example 1, roll molding was tried but molding cloud not be made.

### Preparation Example 1

To obtain slurry having solid content of 25%, 100 parts of electrode active material (activated carbon having specific surface area of 2000 m²/g and weight average particle diameter of 5 μm), 5 parts of electric conductive material (“Denka Black powder”), 8.68 parts of 64.5% PTFE aqueous dispersion “D-2CE” as the fluororesin (a), 93.3 parts of 1.5% solution (“DN-800H”) of carboxymethyl cellulose as soluble resin, and 242.6 parts of ion exchanged water were stirred and mixed by a TK HomoMixer (produced by Tokushu Kika Kogyo Co., Ltd.). By use of the slurry, spray-drying granulation was carried out in the same manner as in the example 1 to give composite particle (A-2) having average particle diameter of 40 μm.

### Preparation Example 2

Spherical composite particle (B-2) having average particle diameter of 50 μm was obtained in the same manner as in the preparation example 1 except that 14 parts of 40% aqueous dispersion of cross-linked acrylate polymer “AD211” as the amorphous polymer (b) was used in place of the PTFE aqueous dispersion “D-2CE” as the fluororesin (a).

### Example 5

The composite particle (A-2) obtained in the preparation example 1 and the composite particle (B-2) obtained in the preparation example 2 were mixed by 50:50 (weight ratio) to give electrode material. By use of the obtained electrode material, roll molding was carried out in the same manner as in the example 1 to obtain active material layer having thickness of 320 μm, width of 10 cm, and density of 0.59 g/cm³. By use of the active material layer, electrode sheet was obtained in the same manner as in the example 1. The characteristics of the electric double layer capacitor obtained by use of the electrode sheet were measured, and they appeared as electric capacity of 55 F/g, internal resistance of 11.2Ω, and capacity retention ratio of 93.9%.

### Example 6

The composite particle (A-2) obtained in the preparation example 1 and the composite particle (B-2) obtained in the preparation example 2 were mixed by 70:30 (weight ratio) to give electrode material. By use of the obtained electrode material, roll molding was carried out in the same manner as in the example 1 to obtain active material layer having thickness of 330 μm, width of 10 cm, and density of 0.59 g/cm³. By use of the active material layer, electrode sheet was obtained in the same manner as in the example 1. The characteristics of the electric double layer capacitor obtained by use of the electrode sheet were measured, and they appeared as electric capacity of 55 F/g, internal resistance of 11.0Ω, and capacity retention ratio of 93.2%.

### Example 7

The composite particle (A-2) obtained in the preparation example 1 and the composite particle (B-2) obtained in the preparation example 2 were mixed by 30:70 (weight ratio) to give electrode material. By use of the obtained electrode material, roll molding was carried out in the same manner as in the example 1 to obtain active material layer having thickness of 310 μm, width of 10 cm, and density of 0.59 g/cm³. By use of the active material layer, electrode sheet was obtained in the same manner as in the example 1. The characteristics of the electric double layer capacitor obtained by use of the electrode sheet were measured, and they appeared as electric capacity of 54 F/g, internal resistance of 11.6Ω, and capacity retention ratio of 94.3%.

The above result shows that using of electrode material of the present invention can allow to form active material layer continuously at a high molding rate. And it is known that electric double layer capacitor electrode or electric double layer capacitor which is produced by use of the obtained active material layer has a high electrostatic capacity, low internal resistance, and high capacity retention ratio at repeating charge and discharge.

On the other hand, when only the fluororesin (a) is used as the binder to be used for the electrode material, although the molding rate of the active material layer can be made high, it is difficult to form it continuously. Moreover, the electric double layer capacitor obtained by use of the active material layer has low capacity retention ratio at repeating charge and discharge. It is presumed that this is because the binding force declines in connection with the repetition of charge and discharge, and the active material layer falls off the collector (see Comparative Example 1). Moreover, when only the amorphous polymer (b) is used as the binder to be used for the electrode material, it is not possible to form the active material layer at a high molding rate (see Comparative Example 2).

1-12. (canceled)

13. An electrochemical element electrode material comprising:
composite particle (a) comprising electrode active material, electric conductive material, fluororesin (a) and amorphous polymer (b), and/or
a mixture of composite particle (A) comprising electrode active material, electric conductive material, and fluororesin (a), and composite particle (B) comprising electrode active material, electric conductive material, and amorphous polymer (b);
wherein the fluororesin (a) has a structure unit obtained by polymerizing tetrafluoroethylene and has a melting point of 200° C. or higher, and
the amorphous polymer (b) does not have a structure unit obtained by polymerizing tetrafluoroethylene and has a glass transition temperature of 180° C. or lower.

14. The electrochemical element electrode material according to claim 13, comprising the composite particle (a).

15. The electrochemical element electrode material according to claim 13 comprising a mixture of the composite particle (A) and the composite particle (B).

16. The electrochemical element electrode material according to claim 13, further comprising a resin (c) other than the fluororesin (a) and the amorphous polymer (b).

17. The electrochemical element electrode material according to claim 13, wherein the resin (c) is a resin soluble in solvent.

18. A composite particle (a) comprising
electrode active material,
electric conductive material,
fluororesin (a) having a structure unit obtained by polymerizing tetrafluoroethylene and having a melting point of 200° C. or higher, and
amorphous polymer (b) not having a structure unit obtained by polymerizing tetrafluoroethylene and having a glass transition temperature of 180° C. or lower.

19. A method of producing composite particle comprising steps of:
dispersing
electrode active material,
electric conductive material,
fluororesin (a) having a structure unit obtained by polymerizing tetrafluoroethylene and having a melting point of 200° C. or higher, and
amorphous polymer (b) not having a structure unit obtained by polymerizing tetrafluoroethylene and having a glass transition temperature of 180° C. or lower, in solvent to obtain slurry A, and
granulating by spray-drying of the slurry A.

20. A method of producing composite particle comprising steps of:
dispersing
electric conductive material,
fluororesin (a) having a structure unit obtained by polymerizing tetrafluoroethylene aid having a melting point of 200° C. or higher, and
amorphous polymer (b) not having a structure unit obtained by polymerizing tetrafluoroethylene and having a glass transition temperature of 180° C. or lower, in solvent to obtain slurry B, and
fluidized-granulating by fluidizing of electrode active material in a column, and spraying of the slurry B thereto.

21. An electrochemical element electrode, wherein active material layer comprising the electrochemical element electrode material according to claim 13 is laminated on a collector.

22. The electrochemical element electrode according to claim 21, wherein the active material layer is formed by press molding.

23. The electrochemical element electrode according to claim 22, wherein the press molding is roll-press molding.

24. The electrochemical element electrode according to claim 21, for an electric double layer capacitor.
